(19) United States
(12) Patent Application Publication
(10) Pub. No.: US 2013/0095408 A1
(43) Pub. Date: Apr. 18, 2013

(54) ANODE MATERIAL FOR SOLID OXIDE FUEL CELL, AND ANODE AND SOLID OXIDE FUEL CELL INCLUDING ANODE MATERIAL

(71) Applicants: Doh-won JUNG, Seoul (KR); Dong-hee YEON, Seoul (KR); Hee-jung PARK, Suwon-si (KR); Chan KWAK, Yongin-si (KR); Soo-yeon SEO, Seoul (KR); Sang-mock LEE, Yongin-si (KR)

(72) Inventors: Doh-won JUNG, Seoul (KR); Dong-hee YEON, Seoul (KR); Hee-jung PARK, Suwon-si (KR); Chan KWAK, Yongin-si (KR); Soo-yeon SEO, Seoul (KR); Sang-mock LEE, Yongin-si (KR)

(73) Assignee: SAMSUNG ELECTRONICS CO. LTD., Suwon-si (KR)

(21) Appl. No.: 13/541,082

(22) Filed: Jul. 3, 2012

(30) Foreign Application Priority Data
Oct. 14, 2011 (KR) 10-2011-0105532

(51) Int. Cl. H01M 4/90; H01M 4/92; H01M 8/10

(52) U.S. Cl. 429/482; 502/337; 502/324; 502/331; 502/329; 502/302; 502/328; 502/303; 502/306; 502/326

(57) ABSTRACT

A composite anode material for a solid oxide fuel cell (SOFC), an anode for a SOFC including a Ni-containing alloy including Ni and a transition metal other than Ni; and a perovskite metal oxide having a perovskite structure.

This application claims priority to and the benefit of Korean Patent Application No. 10-2011-0105532, filed on Oct. 14, 2011, and all the benefits accruing therefrom under 35 U.S.C. §119, the content of which is incorporated herein in its entirety by reference.

### BACKGROUND

1. Field

The present disclosure relates to a composite anode material for a solid oxide fuel cell (SOFC), and an anode and a SOFC including the composite anode material.

2. Description of the Related Art

Solid oxide fuel cells (SOFCs) are highly-efficient and environmentally-friendly electrochemical power generation devices that directly convert chemical energy of a fuel gas (hydrogen or hydrocarbon) into electrical energy. SOFCs use an ion-conductive solid oxide electrolyte. An SOFC includes an anode (i.e., a fuel electrode) where oxidation of fuel such as hydrogen or hydrocarbon takes place, a cathode (i.e., an air electrode) where reduction of oxygen gas to oxygen ions (O²⁻) occurs, and an ion conductive solid oxide electrolyte for conducting the oxygen ions (O²⁻).

Recently, to improve cost and durability, a significant amount of research has been conducted to provide an SOFC having a reduced operating temperature. When the operating temperature is reduced, kinetics at the anode and the cathode are reduced, increasing polarization resistance. In particular, with regard to an anode, in order to reduce polarization resistance of the anode, active research has been conducted into an SOFC that can maintain performance even after long-term operation, as well as into new anode compositions. Thus there remains a need for an improved anode material for a solid oxide fuel cell.

### SUMMARY

Provided is a composite anode material for a solid oxide fuel cell (SOFC), which provides reduced anode polarization resistance.

Provided is an anode for a SOFC including the composite anode material.

Provided is a SOFC including the composite anode material.

Additional aspects will be set forth in part in the description which follows and, in part, will be apparent from the description.

According to an aspect, a composite anode material for a solid oxide fuel cell (SOFC) includes a Ni-containing alloy including Ni and a transition metal other than Ni; and a perovskite metal oxide having a perovskite structure.

The Ni-containing alloy may be represented by Formula 1 below:

Ni₁₋ₓM^{a}ₓ Formula 1

wherein M^{a} is at least one selected from iron (Fe), cobalt (Co), manganese (Mn), copper (Cu), and zinc (Zn), and 0<x≦0.4.

The perovskite metal oxide may be represented by Formula 2 below:

AM^{b}O_{3-δ} Formula 2

wherein A is at least one selected from a lanthanide, a rare earth element, and an alkaline-earth element,

M^{b} is at least one selected from a transition metal, and

δ is selected such that the perovskite metal oxide represented by Formula 2 is electrostatically neutral.

The perovskite metal oxide may be represented by Formula 3:

A′₁₋ₓA″ₓM^{b}′_{1-y}M^{b}″_{y}O_{y}O_{3-δ} Formula 3

wherein A′ is at least one selected from lanthanum (La) and barium (Ba),

A″ is at least one selected from strontium (Sr), calcium (Ca), samarium (Sm), and gadolinium (Gd),

M^{b}′ and M^{b}″ are different and are each independently at least one selected from chromium (Cr), manganese (Mn), iron (Fe), cobalt (Co), nickel (Ni), copper (Cu), titanium (Ti), vanadium (V), niobium (Nb), ruthenium (Ru), and scandium (Sc),

0≦x<1, 0≦y<1, and

δ is selected such that the perovskite metal oxide represented by Formula 3 is electrostatically neutral.

The Ni-containing alloy and the perovskite metal oxide may be a composite including a nano-sized particle.

An amount of the Ni-containing alloy may be about 1 weight percent (wt %) to about 99 wt %, and an amount of the perovskite metal oxide may be about 1 wt % to about 99 wt %, each based on a total weight of the Ni-containing alloy and the perovskite metal oxide.

According to another aspect, a composite anode material for a SOFC includes a complex oxide including a nickel oxide and an oxide of a transition metal other than Ni, for forming a Ni-containing alloy by reduction; and a perovskite metal oxide.

The oxide of a transition metal may be at least one selected from Fe, Co, Mn, Cu, and Zn.

The Ni-containing alloy may be represented by Formula 1 above.

The perovskite metal oxide may be represented by Formula 3 above.

According to another aspect, an anode for a solid oxide fuel cell (SOFC) includes the composite anode material.

According to another aspect, a solid oxide fuel cell (SOFC) includes an anode including the composite anode material; a cathode facing the anode; and a solid oxide electrolyte disposed between the anode and the cathode.

The anode may have a thickness of about 1 micrometer (μm) to about 1000 μm.

The solid oxide electrolyte may include at least one selected from a zirconia which is undoped or includes at least one selected from yttrium (Y), scandium (Sc), calcium (Ca), and magnesium (Mg); a ceria which is undoped or include at least one selected from gadolinium (Gd), samarium (Sm), lanthanum (La), ytterbium (Yb), and neodymium (Nd); a lanthanum gallate which is undoped or includes at least one selected from strontium (Sr) and magnesium (Mg); and a bismuth compound which is undoped or includes at least one selected from calcium (Ca), strontium (Sr), barium (Ba), gadolinium (Gd), and yttrium (Y).

The cathode may include at least one selected from (La,Sr)MnO₃, (La,Ca)MnO₃, (Sm,Sr)CoO₃, (La,Sr)CoO₃, (La,Sr)(Fe,Co)O₃, (La,Sr)(Fe,Co,Ni)O₃, and (Ba,Sr)(Co,Fe)O₃. For example, the cathode may include a compound represented by Formula 4:

Ba_{a′}Sr_{b′}Co_{x′}Fe_{y′}M′_{1-x′-y′}O_{3-η} Formula 4

wherein M′ is at least one selected from a transition element and a lanthanide,

a′ and b′ satisfy 0.4≦a′≦0.6, and 0.4≦b′≦0.6, respectively,

x′ and y′ satisfy 0.6≦x′≦0.9, and 0.1≦y′≦0.4, respectively, and

η is selected such that the compound represented by Formula 4 is electrostatically neutral.

The SOFC may further include a functional layer disposed between the cathode and the solid oxide electrolyte which is effective to prevent a reaction between the cathode and the solid oxide electrolyte.

The functional layer may include at least one selected from gadolinia-doped ceria (GDC), samaria-doped ceria (SDC), and yttria-doped ceria (YDC).

### BRIEF DESCRIPTION OF THE DRAWINGS

These and/or other aspects will become apparent and more readily appreciated from the following description of the embodiments, taken in conjunction with the accompanying drawings in which:

FIG. 1 is a conceptual diagram of a triple phase boundary (TPB) of an anode;

FIG. 2 is a schematic cross-sectional view of a structure of an embodiment of a solid oxide fuel cell (SOFC);

FIG. 3 is a graph of intensity (arbitrary units) versus scattering angle (degrees two-theta, 2θ, and shows the results of X-ray diffraction (XRD) analysis of La_{0.75}Sr_{0.25}Cr_{0.5}Mn_{0.5}O₃ synthesized in Preparation Example 1;

FIG. 4 is a scanning electron microscope (SEM) image of the La_{0.75}Sr_{0.25}Cr_{0.5}Mn_{0.5}O₃ powder synthesized in Preparation Example 1;

FIG. 5 is a graph of intensity (arbitrary units) versus scattering angle (degrees two-theta (2θ) and shows results of XRD analysis of the complex oxide NiO—Fe₂O₃ obtained in Preparation Example 1;

FIG. 6 is a graph of intensity (arbitrary units) versus scattering angle (degrees two-theta (2θ) and shows results of XRD analysis of the complex oxide NiO—Fe₂O₃ obtained in Preparation Example 2;

FIG. 7 is a graph of intensity (arbitrary units) versus scattering angle (degrees two-theta (2θ) and shows results of XRD phase analysis of the NiO—Fe₂O₃ synthesized in Preparation Example 1 and the La_{0.75}Sr_{0.25}Cr_{0.5}Mn_{0.5}O₃ during manufacture of the complex in an air atmosphere and during a reduction process in a hydrogen atmosphere;

FIG. 8 is a graph of intensity (arbitrary units) versus scattering angle (degrees two-theta (2θ) and shows results of XRD phase analysis of the NiO and the La_{0.75}Sr_{0.25}Cr_{0.5}Mn_{0.5}O₃ that are used in Comparative Preparation Example 2 during manufacture of the complex in an air atmosphere and during a reduction process in a hydrogen atmosphere;

FIG. 9 is a SEM image of a Ni_{0.7}Fe_{0.3}-LSCM composite anode material that is obtained using the NiO—Fe₂O₃ synthesized in Preparation Example 1 and La_{0.75}Sr_{0.25}Cr_{0.5}Mn_{0.5}O₃;

FIG. 10 is a graph of log anode resistance (ohms-square centimeters, Ωcm²) versus reciprocal temperature (1000/T, Kelvin⁻¹ (K⁻¹)) which shows the results of anode resistance measurement according to an operating temperature of symmetrical cells prepared in Examples 1 to 3 and Comparative Examples 1 and 2;

FIG. 11 is a graph of imaginary resistance (Z₂, ohms-square centimeters, Ωcm²) versus real resistance (Z₁, ohms-square centimeters, Ωcm²) which shows the results of impedance measurement of symmetrical cells prepared in Examples 1 to 4 and Comparative Examples 1 and 2;

FIG. 12 is a graph of voltage (volts, V) and power density (watts per square centimeter, W/cm²) versus current density (amperes per square centimeter, A/cm²) and is a comparison of current-voltage (I-V) and current-power density (I-P) results of Example 5 and Comparative Example 3; and

FIG. 13 is a graph of voltage (volts, V) and power density (watts per square centimeter, W/cm²) versus current density (amperes per square centimeter, A/cm²) and is a comparison of I-V and I-P results of Example 5 and Comparative Example 4.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Transition metal” refers to an element of Groups 3-12, other than a lanthanide.

“Rare earth” means the fifteen lanthanide elements, i.e., atomic numbers 57 to 71, plus scandium and yttrium.

“Lanthanide” means an element of atomic numbers 57 to 71.

“Alkaline-earth” means an element of Group 2 of the Periodic Table of the Elements, i.e., beryllium, magnesium, calcium, strontium, barium, and radium.

A composite anode material for a solid oxide fuel cell (SOFC) according to an embodiment includes a Ni-containing alloy comprising Ni (e.g., a Ni-containing bimetallic alloy) and a transition metal other than Ni; and a perovskite metal oxide having a perovskite structure.

Electrochemical reactions in SOFCs include a cathode reaction, in which oxygen gas (O₂) supplied to an air electrode (i.e., a cathode) is reduced to provide oxygen ions (O²); and an anode reaction, in which a fuel (e.g., H₂ or a hydrocarbon) supplied to a fuel electrode (i.e., an anode) reacts with the O²⁻ that has migrated through an electrolyte to form water. The electrochemical reactions may be represented by the following Reaction Scheme:

Reaction Scheme

Cathode: ½O₂+2e⁻->O²⁻

Anode: H₂+O²⁻->H₂O+2e⁻

An electrolyte may be disposed between the fuel electrode and the air electrode. Continuous flow of hydrogen and air may maintain a constant oxygen pressure, thereby generating a driving force by which oxygen ions transport through the electrolyte. Electrons may the flow to an external wire through the fuel electrode or the air electrode to generate electricity.

A composite anode material for the SOFC according to an embodiment includes a Ni-containing alloy in addition to a perovskite metal oxide. In an area of a triple phase boundary (TPB) where an anode reaction occurs, a contact area of the oxygen ions, hydrogen, and the composite anode may be increased, and sufficient electrical conductivity and ionic conductivity for an anode of the SOFC may be provided, thereby a reducing polarization resistance of the anode.

The Ni-containing alloy is an alloy including nickel (Ni), serves as an oxidation catalyst of hydrogen, is an electronic conductor, and improves an electronic conductivity and catalyst activity of the anode material including the perovskite metal oxide. According to an embodiment, the Ni-containing alloy may be a Ni-containing bimetallic alloy. The Ni-containing alloy may be an alloy of Ni and a transition metal other than Ni. The Ni-containing alloy may be in the form of a solid solution, such as a solid solution that may be formed by dissolving a transition metal other than Ni in Ni to provide a homogeneous phase. It may be seen that the Ni-containing alloy has excellent catalyst efficiency compared to a catalyst consisting of Ni, as is further illustrated herein.

According to an embodiment, the Ni-containing alloy may be represented by Formula 1:

Ni₁₋ₓM^{a}ₓ Formula 1

In Formula 1, M^{a} is at least one selected from iron (Fe), cobalt (Co), manganese (Mn), copper (Cu), and zinc (Zn), and 0<x≦0.4.

According to an embodiment, M^{a} may be Fe or Co.

In Formula 1, x indicates an amount of transition metal that is disposed in (e.g., dissolved in) Ni, e.g., a Ni crystal, and 0<x≦0.4, specifically, 0<x≦0.3.

The Ni-containing alloy may be synthesized using an impregnation method which includes impregnating NiO with a transition metal other than Ni. When the impregnation method is used, the Ni-containing alloy may be prepared by reducing a complex oxide of nickel oxide and a transition metal oxide of the transition metal other than Ni, which may be obtained by combining a selected amount of nickel nitride and a transition-metal nitride of the transition metal other than Ni in a solvent and mixing and heat-treating the nickel nitride and the transition-metal nitride in a H₂ atmosphere. Alternatively, to manufacture an anode, the Ni-containing alloy may be prepared directly from the complex oxide of the impregnated nickel oxide and the transition-metal oxide in a process in which the complex oxide of the impregnated nickel oxide and the transition-metal oxide is naturally reduced by H₂ in the reducing conditions of an anode during operation of a SOFC.

The anode material for the SOFC includes a perovskite metal oxide in addition to the Ni-containing alloy. The perovskite metal oxide constitutes a matrix of the anode of the SOFC in which the Ni-containing alloy particles may be dispersed. Since the perovskite metal oxide has excellent redox stability and is a mixed ionic and electronic conductor having both ionic conductivity and electrical conductivity, the perovskite metal oxide provides suitable electrode activity at a low temperature, thereby reducing polarization resistance of the anode.

According to an embodiment, the perovskite metal oxide may be represented by, for example, Formula 2:

AM^{b}O_{3-δ} Formula 2

In Formula 2, A is at least one selected from a lanthanide, a rare earth element, and an alkaline-earth element,

M^{b} is at least one selected from a transition metal, and

δ is selected such that the perovskite metal oxide represented by Formula 2 is electrostatically neutral.

According to an embodiment, the perovskite metal oxide of Formula 2 may be represented by Formula 3:

A′₁₋ₓA″ₓM^{b}′_{1-y}M^{b}″_{y}O_{3-δ} Formula 3

In Formula 3, A′ is at least one of lanthanum (La) and barium (Ba),

A″ is at least one selected from strontium (Sr), calcium (Ca), samarium (Sm), and gadolinium (Gd),
M^{b}′ and M^{b}″ are different and are each independently at least one selected from chromium (Cr), manganese (Mn), iron (Fe), cobalt (Co), nickel (Ni), copper (Cu), titanium (Ti), vanadium (V), niobium (Nb), ruthenium (Ru), and scandium (Sc),
0≦a<1, 0≦b<1, and
δ is selected such that the perovskite metal oxide represented by Formula 3 is electrostatically neutral.

The perovskite metal oxide may be used alone or in a combination of at least one thereof. According to an embodiment, the perovskite metal oxide may comprise at least one selected from lanthanum strontium chrome manganese oxide (LSCM), lanthanum strontium chrome vanadium oxide (LSCV), lanthanum strontium chrome ruthenium oxide, lanthanum strontium chrome nickel oxide, lanthanum strontium chrome titanium oxide, lanthanum strontium titanium cerium oxide, lanthanum strontium cobalt iron oxide (LSCF), lanthanum calcium chrome titanium oxide, lanthanum strontium gallium magnesium oxide, barium strontium cobalt iron oxide (BSCF), barium strontium cobalt titanium oxide (BSCT), barium strontium zinc iron oxide (BSZF), and an oxide doped with any of the foregoing. For example, the oxide may be at least one selected from La_{0.75}Sr_{0.25}Cr_{0.5}Mn_{0.5}O₃, La_{0.8}Sr_{0.2}Cr_{0.97}V_{0.03}O₃, La_{0.7}Sr_{0.3}Cr_{0.95}Ru_{0.5}O₃, La₁₋ₓSrₓCr_{1-y}Ni_{y}O₃, La_{0.8}Sr_{0.2}Cr_{0.8}Mn_{0.2}O₃, La_{0.75}Sr_{0.25}Cr_{0.5}Mn_{0.5}O₃, La_{0.6}Sr_{0.4}Fe_{0.8}CO_{0.2}O₃, La₁₋ₓCaₓCr_{0.5}Ti_{0.5}O₃ wherein 0x≦1, La_{0.7}Sr_{0.3}Cr_{0.8}Ti_{0.2}O₃, (La,Sr)(Ti, Ce)O₃, La_{0.9}Sr_{0.1}Ga_{0.8}Mn_{0.2}O₃, La₄Sr₈Ti₁₁Mn_{0.5}Ga_{0.5}O_{37.5}, (Ba_{0.5}Sr_{0.5})₁₋ₓSmₓCo_{0.8}Fe_{0.2}O_{3-δ} wherein 0.05≦x≦0.15 (BSSCF), Ba_{0.6}Sr_{0.4}Co_{1-y}Ti_{y}O_{3-δ} (BSCT), and Ba_{0.5}Sr_{0.5}Zn_{0.2}Fe_{0.8}O_{3-δ} (BSZF).

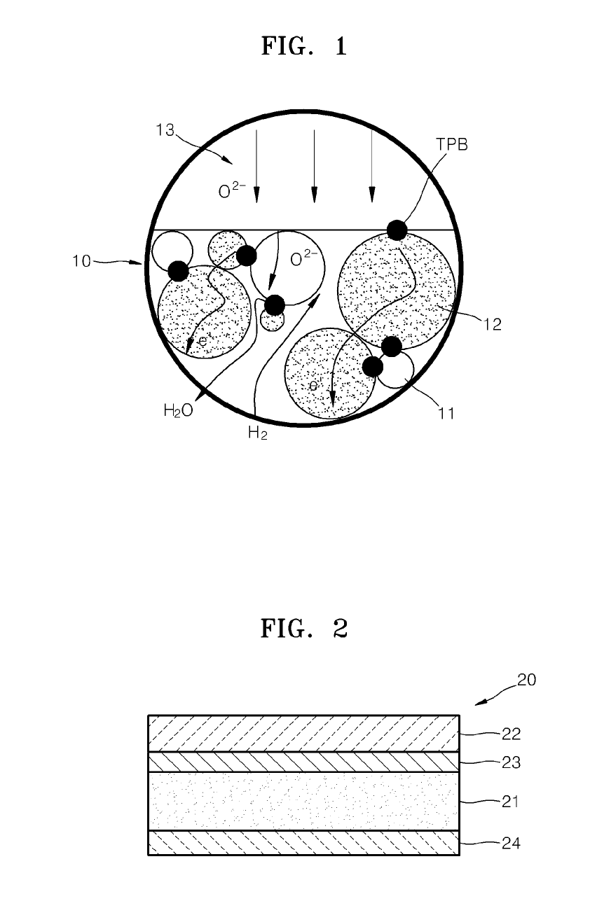

The anode material for the SOFC may be a composite comprising the Ni-containing alloy and the perovskite metal oxide, wherein each independently may be in the form of a nano-sized particle. Use of nano-sized particles may provide improved porosity and may increase a size of a TPB. A conceptual diagram of a TPB of an anode of an SOFC is shown in FIG. 1. As shown in FIG. 1, in the anode material 10, oxygen ions O²⁻, that move through an electrolyte 13, react with a fuel (e.g., H₂ or a hydrocarbon) at a TPB where a Ni-containing alloy 11 (which is an electronic conductor), and a perovskite metal oxide 12 (which is a mixed conductor), and pores contact each other to form H₂O and generate electricity. In an embodiment in which the anode material is a composite comprising particles, an area of a TPB may be increased, facilitating the anode reaction.

According to an embodiment, in a composite anode material for the SOFC, the Ni-containing alloy may comprise particles having an average diameter (e.g., average largest diameter) of 300 nanometers (nm) or less, for example, 200 nm or less, or 100 nm or less, specifically 5 to 300 nm, more specifically 10 to 200 nm. The perovskite metal oxide may have a particle size which is greater than that of a particle size of the Ni-containing alloy and may have a particle size of, for example, about 1 micrometer (μm) or less, specifically 0.01 to 1 μm, more specifically 0.1 to 0.8 μm. The perovskite metal oxide having such a particle size may provide a three-dimensional pore channel structure in the composite anode. In addition, an embodiment wherein the Ni-containing alloy has a smaller particle size than that of the perovskite metal oxide may increase a size of the TPB of the anode so as to increase an anode performance.

In the composite anode material for the SOFC, the amount of the Ni-containing alloy and the amount of the perovskite metal oxide may be selected in consideration of the anode resistance, power density, and the like. For example, the amount of the Ni-containing alloy may be about 1 weight percent (wt %) to about 99 wt %, and the amount of the perovskite metal oxide may be about 1 wt % to about 99 wt %, each based on the total weight of the Ni-containing alloy and the perovskite metal oxide. According to an embodiment, the amount of the Ni-containing alloy may be about 10 wt % to about 90 wt %, and the amount of the perovskite metal oxide may be about 10 wt % to about 90 wt %, each based on the total weight of the Ni-containing alloy and the perovskite metal oxide. In more detail, the amount of the Ni-containing alloy may be about 30 wt % to about 70 wt %, and the amount of the perovskite metal oxide may range from about 30 wt % to about 70 wt %, each based on the total weight of the Ni-containing alloy and the perovskite metal oxide.

According to another embodiment, a composite anode material for a SOFC may include a complex oxide including a nickel oxide and an oxide of a transition metal other than Ni, which is suitable for forming a Ni-containing alloy by reduction; and a perovskite metal oxide.

In an embodiment, the transition metal refers to an element of Groups 3-12 other than a lanthanide. According to an embodiment, the transition metal is a metal (M^{a}) selected from Fe, Co, Mn, Cu, and Zn.

The complex oxide including the nickel oxide and the transition metal may be prepared by, for example, an impregnation method, or the like. During the preparation of an anode material comprising the complex oxide, a Ni-containing alloy may be formed through an additional reduction process. Alternately, the complex oxide may be used directly in an anode and then the complex oxide is naturally reduced by H₂ in the reducing atmosphere of an anode during operation of the SOFC, so as to form a Ni-containing alloy.

Through such a reduction, the complex oxide is used to form a Ni-containing alloy represented by, for example, Formula 1:

Ni₁₋ₓM^{a}ₓ Formula 1

In Formula 1, M^{a} is an atom selected from Fe, Co, Mn, Cu, and Zn, and 0<x≦0.4.

In Formula 1, x indicates an amount of transition metal that is dissolved in the Ni. In addition, a molar ratio of a nickel oxide and a transition metal oxide may be selected so as to obtain a composition of Formula 1 satisfying 0<x≦0.4.

The perovskite metal oxide may be represented by, for example, Formula 2:

AM^{b}O_{3-δ} Formula 2

In Formula 2, A is at least one selected from a lanthanide, a rare earth element, and an alkaline-earth element,

M^{b} is at least one selected from a transition metal, and

δ is selected such that the perovskite metal oxide represented by Formula 2 is electrostatically neutral.

According to an embodiment, the perovskite metal oxide represented by Formula 2 may have a composition of Formula 3:

A′₁₋ₓA″ₓM^{b}′_{1-y}M^{b}″_{y}O_{3-δ} Formula 3

In Formula 3, A′ is at least one selected from La and Ba,

A″ is at least one selected from Sr, Ca, Sm, and Gd,

M^{b}′ and M^{b}″ are different and are each independently at least one selected from Cr, Mn, Fe, Co, Ni, Cu, Ti, V, Nb, Ru, and Sc,

0≦a<1, 0≦b<1, and

δ is selected such that the perovskite metal oxide represented by Formula 3 is electrostatically neutral.

The perovskite metal oxide may be used alone or in a combination of at least one thereof. According to an embodiment, the perovskite metal oxide may comprise LSCM. For example, an oxide such as La_{0.75}Sr_{0.25} Cr_{0.5}Mn_{0.5}O₃, or the like may be used.

The perovskite metal oxide is further described above, and thus will be not described in detail again.

In the composite anode material for the SOFC, the amount of the complex oxide and the amount of the perovskite metal oxide may be determined in consideration of anode resistance, power density, and the like. For example, the amount of the complex oxide may be about 1 wt % to about 99 wt % and the amount of the perovskite metal oxide may be about 1 wt % to about 99 wt %, each based on the total weight of the complex oxide and the perovskite metal oxide. According to an embodiment, the amount of the complex oxide may be about 10 wt % to about 90 wt % and the amount of the perovskite metal oxide may be about 10 wt % to about 90 wt %, each based on the total weight of the complex oxide and the perovskite metal oxide. In more detail, the amount of the complex oxide may be about 30 wt % to about 70 wt % and the amount of the perovskite metal oxide may be about 30 wt % to about 70 wt %, each based on the total weight of the complex oxide and the perovskite metal oxide.

According to another embodiment, an anode for a SOFC may include the composite anode material.

According to another embodiment, an SOFC may include the composite anode material. The solid oxide fuel cell includes an anode including the above-described anode material; a cathode facing the anode; and a solid oxide electrolyte disposed between the anode and the cathode.

FIG. 2 is a schematic cross-sectional view of a structure of a SOFC 20 according to an embodiment. Referring to FIG. 2, the SOFC 20 includes a cathode 22 and an anode 24 disposed on opposite sides of a solid oxide electrolyte 21.

The solid oxide electrolyte 21 is desirably dense enough to prevent mixing of air and a fuel, has sufficient oxygen ion conductivity, and has a suitable electron conductivity. Because the solid oxide electrolyte 21 is disposed between the cathode 22 and the anode 24 and supports a large change in oxygen partial pressure, the solid oxide electrolyte 21 is desirably able to maintain suitable physical properties over a wide range of oxygen partial pressure.

A material of the solid oxide electrolyte 21 is not specifically limited and may be any material commonly used in the art. For example, the solid oxide electrolyte 21 may include at least one selected from a zirconia-based solid electrolyte, a ceria-based solid electrolyte, a bismuth-based solid electrolyte, and a lanthanum gallate-based solid electrolyte. For example, the solid oxide electrolyte 21 may include at least one selected from a zirconia-based material which is undoped or comprises at least one of yttrium (Y), scandium (Sc), calcium (Ca), and magnesium (Mg); a ceria-based material which is undoped or comprises at least one of gadolinium (Gd), samarium (Sm), lanthanum (La), ytterbium (Yb), and neodymium (Nd); a lanthanum gallate-based material which is undoped or comprises at least one of strontium (Sr) and magnesium (Mg); and a bismuth-based material which is undoped or comprises at least one of calcium (Ca), strontium (Sr), barium (Ba), gadolinium (Gd), and yttrium (Y). Examples of the solid oxide electrolyte 21 may include yttrium-stabilized zirconia (YSZ), scandium-stabilized zirconia (SSZ), samarium-doped ceria (SDC), and gadolinium-doped ceria (GDC).

The solid oxide electrolyte 21 may have a thickness of about 10 nanometers (nm) to about 100 μm, and in an embodiment, may have a thickness of about 100 nm to about 50 μm.

The cathode (air electrode) 22 may reduce oxygen gas to provide oxygen ions and may allow for continuous flow of air to maintain a constant partial oxygen pressure. A material for forming the cathode 22 may be, for example, a metal oxide particle having a perovskite-type crystal structure, such as at least one oxide selected from (La,Sr)MnO₃, (La,Ca)MnO₃, (Sm,Sr)CoO₃, (La,Sr)CoO₃, (La,Sr)(Fe,Co)O₃, (La,Sr)(Fe,Co,Ni)O₃, (Ba,Sr)(Co,Fe)O₃, and the like. According to an embodiment, the cathode 22 may comprise a metal oxide that is obtained by doping (Ba,Sr)(Co,Fe)O₃ (BSCF) having a perovskite-type crystal structure with a transition metal atom or a lanthanide. While not wanting to be bound by theory, it is understood that the metal oxide provides improved stability by improving thermal expansion properties of the BSCF. For example, a compound represented by Formula 4 below may be used as the improved BSCF-based cathode material.

Ba_{a′}Sr_{b′}Co_{x′}Fe_{y′}M′_{1-x′-y′}O_{3-η} Formula 4

In Formula 4, M′ is at least one selected from a transition element and a lanthanide,

a′ and b′ may satisfy 0.4≦a′≦0.6, and 0.4≦b′≦0.6, respectively,

x′ and y′ may satisfy 0.6≦x′≦0.9, and 0.1≦y′≦0.4, respectively, and

η is selected such that the compound represented by Formula 4 is electrostatically neutral.

In an embodiment, M′ may be at least one selected from Mn, Zn, Ni, Ti, Nb, Cu, Ho, Yb, Er, and Tm.

A material for forming a layer of the air electrode may be a noble metal such as platinum (Pt), ruthenium (Ru), palladium (Pd), or the like. The above described examples of the cathode material may be used alone or in a combination of at least one thereof. In addition, a single-layered cathode or a multi-layered cathode comprising different cathode materials may be used.

The cathode 22 may have a thickness of about 1 μm to about 100 μm. For example, the cathode 22 may have a thickness of about 5 μm to about 50 μm.

A functional layer 23 may be further included between the cathode 22 and the solid oxide electrolyte 21 if desired, to more effectively prevent a reaction between the two. The functional layer 23 may include, for example, at least one selected from gadolinia-doped ceria (GDC), samaria-doped ceria (SDC), and yttria-doped ceria (YDC). The functional layer 23 may have a thickness of about 1 to about 50 μm, and in some embodiments, may have a thickness of about 2 μm to about 10 μm.

The anode 24 is involved in electrochemical oxidation of a fuel and charge transfer. The anode 24 may include the composite anode material for the SOFC, which has been described above, and thus will not be described in further detail.

The anode 24 may have a thickness of about 1 to μm to about 1000 μm. For example, the anode 24 may have a thickness of about 5 μm to about 100 μm.

The SOFC may be manufactured using any suitable process disclosed in literature, the details of which can be determined by one of skill in the art without undue experimentation. The SOFC may be applied to any of a variety of structures, for example, a tubular stack, a flat tubular stack, or a planar stack.

Hereinafter, an exemplary embodiment of the present disclosure will be described in further detail with reference to the following examples. These examples shall not limit the purpose and scope of the present disclosure.

### Preparation Example 1

### Preparation of Composite Anode Material (Ni_{0.7}Fe_{0.3}-LSCM)

A La_{0.75}Sr_{0.25}Cr_{0.5}Mn₀₅O₃ was synthesized as a perovskite metal oxide by using a solid state method. In detail, a total weight of 10 grams (g) of four material powders of La₂O₃, SrCO₃, Cr₂O₃, and Mn₂O₃ were weighted to have a desired composition, and a wet ball mill method using ethyl alcohol was performed on the four material powders. Then, the four material powders were dried while being stirred to obtain powders. The obtained powders were heat-treated for two hours at 1400° C. to obtain pure perovskite-type La_{0.75}Sr_{0.25}Cr_{0.5}Mn_{0.5}O₃ powders (hereinafter, referred to as the ‘LSCM’ with regard to Examples). The obtained La_{0.75}Sr_{0.25}Cr_{0.5}Mn_{0.5}O₃ powders were checked by X-ray diffraction (XRD). In addition, a microstructure of the La_{0.75}Sr_{0.25}Cr_{0.5}Mn_{0.5}O₃ powders was analyzed using a scanning electron microscope (SEM).

In order to prepare a Ni_{0.7}Fe_{0.3} alloy, an impregnation method was used. First, 12.12 g of Fe(NO₃)₃.9H₂O was stirred and dissolved in ethyl alcohol. After the Fe nitrate was completely dissolved, 5.229 g of NiO was put in ethanol, and sonication was performed on the resulting material. Then, the resulting material was added to the Fe nitrate solution, and was dried while being stirred. The dried powders were heat-treated for four hours at 500° C. to obtain a NiO—Fe₂O₃ complex oxide that is obtained by impregnating 0.7 mol of NiO with 0.3 mol of Fe. The complex oxide NiO—Fe₂O₃ was pulverized using a mortar and pestle. The obtained complex oxide NiO—Fe₂O₃ powders were checked by XRD.

Then, the NiO—Fe₂O₃ and LSCM powders were mixed in a weight ratio of 50:50 and were sintered in an air atmosphere for two hours at 1200° C. to form a first phase, and were sintered in a H₂ atmosphere for two hours at 800° C. to obtain a composite anode material Ni_{0.7}Fe_{0.3}-LSCM.

### Preparation Example 2

### Preparation of Composite Anode Material (Ni_{0.9}Fe_{0.1}-LSCM)

A composite anode material Ni_{0.9}Fe_{0.1}-LSCM was obtained in the same manner as in Preparation Example 1, except that the NiO—Fe₂O₃ complex oxide powder that is obtained by impregnating 0.9 mol of NiO with 0.1 mol of Fe using 4.04 g of Fe(NO₃)₃.9H₂O and 6.723 g of NiO was used as the Ni-containing alloy.

### Preparation Example 3

### Preparation of Composite Anode Material (Ni_{0.7}Co_{0.3}-LSCM)

A composite anode material Ni_{0.7}Co_{0.3}-LSCM was obtained in the same manner as in Preparation Example 1, except that NiO—Co₃O₄ powder that is obtained by impregnating 0.7 mol of NiO with 0.3 mol of Co using 8.73 g of Co(NO₃)₂.6H₂O and 5.229 g of NiO is used as the Ni-containing alloy.

### Preparation Example 4

### Preparation of Composite Anode Material (Ni_{0.9}Co_{0.1}-LSCM)

A composite anode material Ni_{0.9}Co_{0.1}-LSCM was obtained in the same manner as in Preparation Example 1, except that NiO—Co₃O₄ powder that is obtained by impregnating 0.9 mol of NiO with 0.1 mol of Co by using 2.9103 g of Co(NO₃)₂.6H₂O and 6.723 g of NiO was used as the Ni-containing alloy.

### Comparative Preparation Example 1

The La_{0.75}Sr_{0.25}Cr_{0.5}Mn_{0.5}O₃ powder synthesized in Preparation Example 1 were used as Comparative Preparation Example 1.

### Comparative Preparation Example 2

An anode material Ni-LSCM that is obtained by sintering the La_{0.75}Sr_{0.25}Cr_{0.5}Mn_{0.5}O₃ powder synthesized in Preparation Example 1 and NiO powder in a weight ratio of 50:50 in an H₂ atmosphere was used as Comparative Preparation Example 2.

### Evaluation Example 1

### Analysis of Composite Anode Material

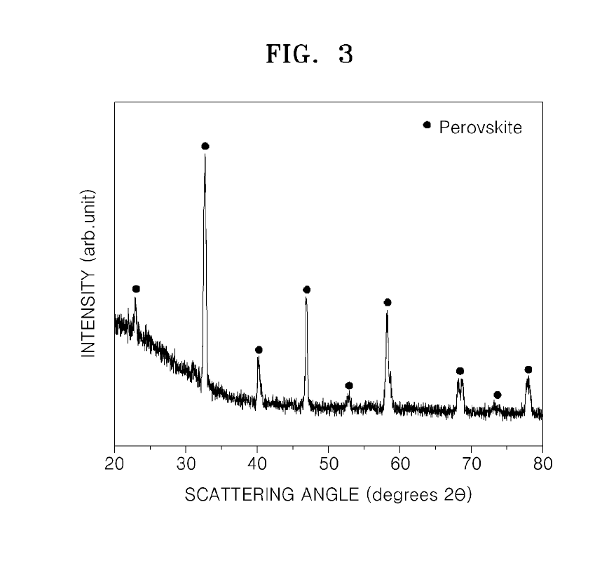

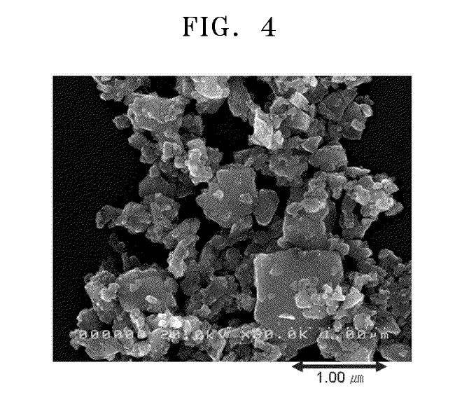

The La_{0.75}Sr_{0.25}Cr_{0.5}Mn_{0.5}O₃ powder synthesized in Preparation Example 1 were analyzed XRD using CuKα radiation. The results are shown in FIG. 3. In order to investigate a microstructure of the La_{0.75}Sr_{0.25}Cr_{0.5}Mn_{0.5}O₃ powder, the La_{0.75}Sr_{0.25}Cr_{0.5}Mn_{0.5}O₃ powder were observed using a scanning electron microscope (SEM). An obtained image is shown in FIG. 4. As shown in FIGS. 3 and 4, perovskite single phase materials were formed and particles with a size of several hundred nanometers were formed. In FIG. 3, peaks corresponding to a perovskite structure are indicated.

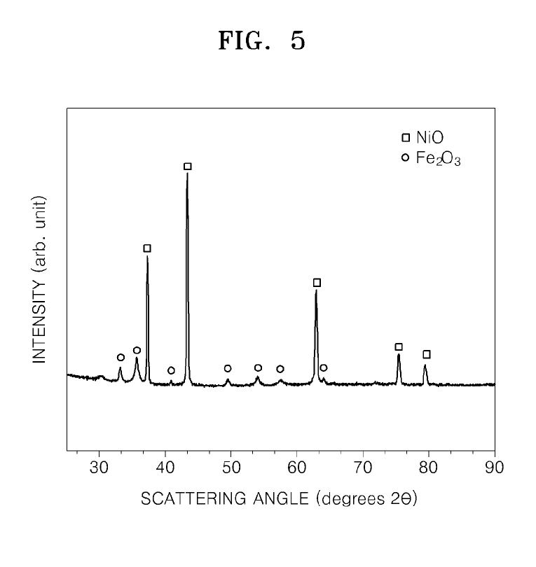

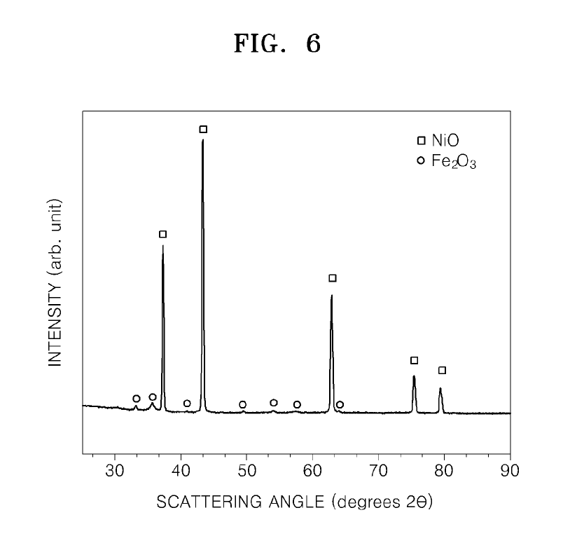

In order to analyze a phase of the Ni-containing alloy, the NiO—Fe₂O₃ complex oxide obtained by impregnation of Fe and heat-treatment (at 500° C.) in Preparation Examples 1 and 2 were analyzed XRD using CuKα rays. The results are shown in FIGS. 5 and 6. As shown in FIGS. 5 and 6, two phases of NiO and Fe₂O₃ coexist in the complex oxide powders obtained by impregnating NiO with 0.3 mol of Fe and 0.1 mol of Fe and heat-treating the resulting material.

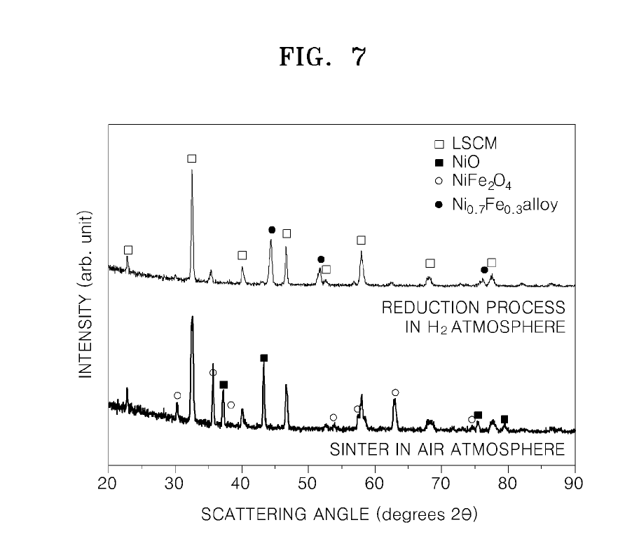

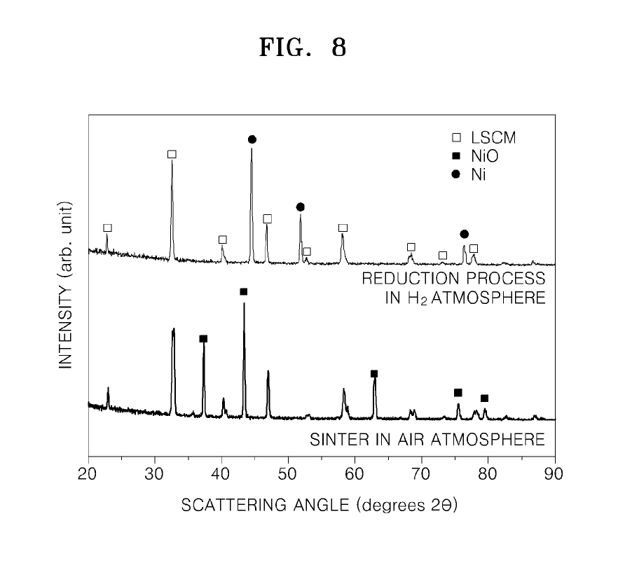

In order to investigate whether a composite is formed and whether a suitable phase is present, phase analysis of a product of the complex oxide preparation process in an air atmosphere and phase analysis of a product of the reduction process in a hydrogen atmosphere were performed on the NiO—Fe₂O₃ synthesized in Preparation Example 1 and La_{0.75}Sr_{0.25}Cr_{0.5}Mn_{0.5}O₃. To this end, powders obtained by mixing the NiO—Fe₂O₃ complex oxide synthesized in Preparation Example 1 and the La_{0.75}Sr_{0.25}Cr_{0.5}Mn_{0.5}O₃ powder at a weight ratio of 1:1 and sintering the resulting material in an air atmosphere for two hours at 1200° C. were analyzed by XRD phase analysis (the results are shown in a lower curve of FIG. 7. In addition, powders obtained by reducing the obtained powders in a reducing (H₂) atmosphere for two hours at 800° C. were analyzed by XRD phase analysis (the results are shown in an upper curve of FIG. 7. For comparison, phase analysis of a complex oxide preparation process in an air atmosphere (the results are shown in a lower curve of FIG. 8) and phase analysis of a product of the reduction process in a hydrogen atmosphere (the results are shown in an upper curve of FIG. 8) were performed in the same manner on the NiO and La_{0.75}Sr_{0.25}Cr_{0.5}Mn_{0.5}O₃ that were used in Comparative Example 2.

Referring to FIG. 7, when the sintering was performed in an air atmosphere, phases of LSCM perovskite and NiO and phases of NiFe₂O₄ having a spinel structure were observed. NiO and NiFe₂O₄ having a spinel structure are formed when a mixture of NiO and Fe₂O₃ is sintered at a high temperature. In addition, in an embodiment wherein powders are reduced in a H₂ atmosphere, two phases of LSCM perovskite and a Ni_{0.7}Fe_{0.3} alloy coexist. As determined by phase analysis, the LSCM perovskite and the Ni_{0.7}Fe_{0.3} alloy stably exist separately without formation of a solid solution and different secondary phases in a reducing atmosphere of a SOFC.

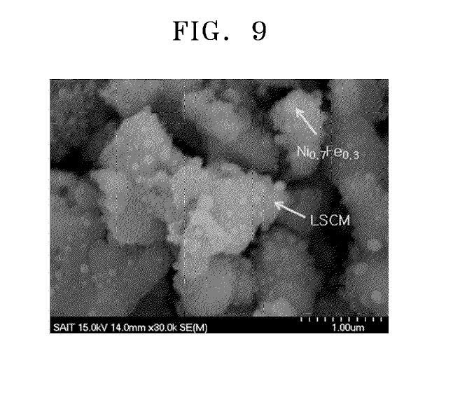

An SEM image of the Ni_{0.7}Fe_{0.3}-LSCM composite anode material after reduction is shown in FIG. 9. As shown in FIG. 9, small particles are Ni_{0.7}Fe_{0.3} particles, and the material supporting the Ni_{0.7}Fe_{0.3} particles are LSCM. The Ni_{0.7}Fe_{0.3} particles have a small size of about 200 nm or less and are regularly distributed on the LSCM particles. A microstructure of the small particles of the Ni-containing alloy may improve a TPB of an anode material to improve performance of an anode.

### Examples 1 to 4

### Preparation of Symmetrical Cell

To measure the performance of an anode material, e.g., anode resistance, a symmetrical cell was manufactured having a pair of anode layers coated on opposite sides of an electrolyte membrane.

When the symmetrical cell was manufactured, the electrolyte membrane was manufactured using scandium-stabilized zirconia (ScSZ) powders (Zr_{0.8}Sc_{0.2}O_{2-ζ}, where ζ is selected so that the zirconia-based metal oxide represented by Zr_{0.8}Sc_{0.2}O_{2-ζ} is electrostatically neutral. The ScSZ powder was obtained from Fuel Cell Materials of Lewis Center, Ohio, USA. In particular, the ScSZ powders were put in a metal mold, and were pressed to form a pellet. The pressed pellet was sintered for 8 hours at 1550° C. to obtain a coin-shaped bulk molded structure, which was about 1 mm-thick.

To form the anode layers on the opposite sides of the electrolyte membrane, the composite anode materials of Preparation Examples 1 to 4 were each mixed with Ink Vehicle (Fuel Cell Materials of Lewis Center, Ohio, USA) to prepare a slurry, which was then coated on the opposite sides of the electrolyte membrane by screen printing. Then, thermal treatment was performed for two hours at 1200° C. to obtain an anode layer having a thickness of 20 μm, thereby completing the manufacture of the symmetrical cell.

### Comparative Examples 1 and 2

### Manufacture of Symmetrical Cell for Comparison

A symmetrical cell for comparison was manufactured in the same manner as in Example 1, except that LSCM and an anode material Ni-LSCM were used as an anode material in Comparative Examples 1 and 2, respectively.

### Evaluation Example 2

### Anode Resistance Measurement

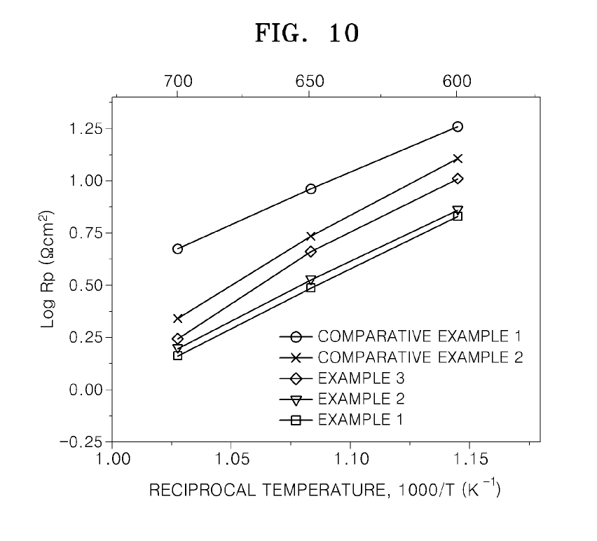

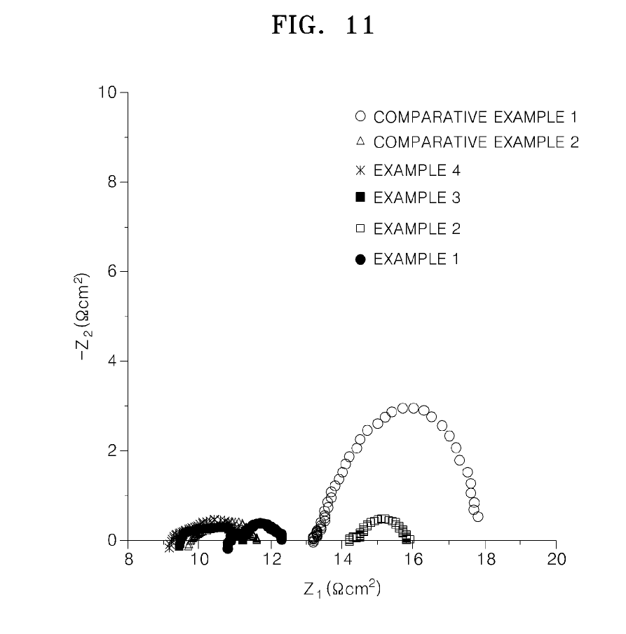

Impedance of each of the symmetric cells prepared in Examples 1 to 3 and Comparative Examples 1 and 2 was measured in an atmosphere of wet H₂ while varying an operating temperature of the symmetric cells. A device used in the impedance analysis was a Materials mates 7260 impedance meter available from Materials mates. Anode resistance Rₚ=Rₜ/2 (½ was set because each cell is symmetric) calculated from a total resistance of the respective symmetric cell, Rₜ, at different operating temperatures, is shown in FIG. 10 as a function of temperature.

Referring to FIG. 10, when a Ni-containing alloy and a LSCM composite are used (Examples 1 to 3), anode resistance, that is, polarization resistance of the symmetrical cell is reduced relative to where LSCM alone (Comparative Example 1) or Ni-LSCM (Comparative Example 2) obtained by a single metal Ni are used. A Ni_{0.7}Fe_{0.3}-LSCM anode had the best performance and has a polarization resistance of ⅓ of when LSCM was used.

### Evaluation Example 3

### Impedance Measurement

Impedance of each of the symmetric cells prepared in Examples 1 to 4 and Comparative Examples 1 to 2 was measured in an atmosphere of wet H₂. The results are shown in FIG. 11. A device used in the impedance analysis was a Materials mates 7260 impedance meter available from Materials mates. In addition, an operational temperature of a cell was maintained to 700° C.

In FIG. 11, the size (diameter) of the semicircles corresponds to the anode resistance (Rₐ). As shown in FIG. 11, in the symmetrical cell of Examples 1 to 4 which used the Ni-containing alloy and the LSCM composite, a smaller semicircle appeared as compared with the symmetrical cell of Comparative Examples 1 and 2, which used LSCM and a mixture of Ni-LSCM.

### Example 5

### Preparation of Full Cell

In order to measure a power density of a fuel cell using the anode material, a full cell was manufactured in the form of an electrolyte support cell. A schematic cross-sectional view of the full cell is shown in FIG. 2.

When the full cell was manufactured, an electrolyte membrane was manufactured using scandium-stabilized zirconia (ScSZ) powders (Zr_{0.8}Sc_{0.2}O_{2-ζ}, where ζ is selected such that the zirconia-based metal oxide represented by Zr_{0.8}Sc_{0.2}O_{2-ζ} is electrostatically neutral (Fuel Cell Materials of Lewis Center, Ohio, USA). In particular, 1.5 g of the ScSZ powders were put in a metal mold having a diameter of 3 cm, and were pressed to form a pellet. The pressed pellet having a thickness of 0.5 mm was sintered for 8 hours at 1550° C., to form an electrolyte membrane.

0.2 g of commercially available FCM Ink vehicle (VEH) (Fuel Cell Materials of Lewis Center, Ohio) was added to 0.4 g of the composite anode material of Ni_{0.7}Fe₀₃-LSCM of Preparation Example 1, and was mixed to prepare a slurry, which was then coated on the electrolyte pellet to a thickness of 40 μm by screen printing. Then, the resulting material was sintered for two hours at 1200° C. to manufacture an anode membrane.

Then, 0.2 g of commercially available FCM Ink vehicle (VEH) (Fuel Cell Materials of Lewis Center, Ohio) was added to 0.3 g of gadolinium-doped ceria (GDC) (Ce_{0.9}Gd_{0.1}O_{2-δ}, where δ is selected so that the ceria-based metal oxide represented by Ce_{0.9}Gd_{0.1}O_{2-δ} is electrostatically neutral (Fuel Cell Materials of Lewis Center, Ohio, USA), and was mixed to prepare a slurry, which was coated on the electrolyte pellet to a thickness of 40 μm by screen printing. Then, the resulting material was sintered for five hours at 1200° C. to manufacture a functional layer.

To form a cathode layer, 0.2 g of commercially available FCM Ink vehicle (VEH) (Fuel Cell Materials of Lewis Center, Ohio, USA) was added to 0.3 g of Ba_{0.5}Sr_{0.5}Co_{0.8}Fe_{0.1}Zn_{0.1}O_{3-η} (where η is selected so that the metal oxide represented by Ba_{0.5}Sr_{0.5}Co_{0.8}Fe₀₁Zn_{0.1}O_{3-η} is electrostatically neutral) powder, and mixed to prepare a slurry, which was then coated to a thickness of 40 μm on the sintered functional layer. Then, the resulting material was sintered for two hours at 900° C. to form a cathode layer, thereby completing the manufacture of the full cell.

### Comparative Examples 3 and 4

### Preparation of Full Cell for Comparison

A full cell for comparison was manufactured in the same manner as in Example 5, except that LSCM and the anode material Ni-LSCM were used as an anode material in Comparative Preparation Examples 1 and 2, respectively.

### Evaluation Example 4

### Measurement of Current-Voltage and Power Density

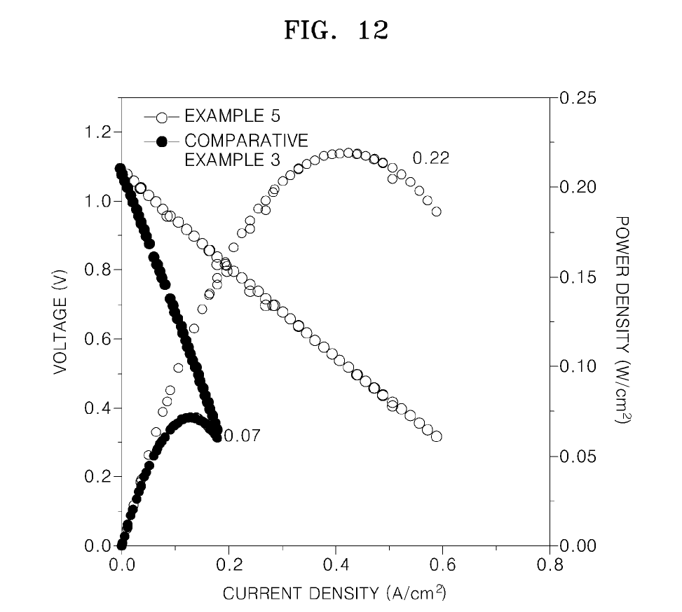

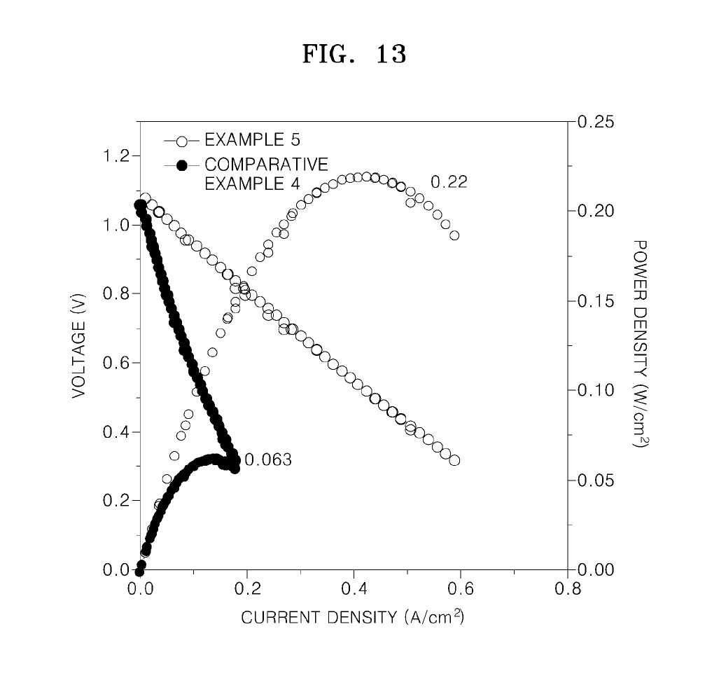

Current-voltage (I-V) and current-power density (I-P) characteristics were measured at 800° C. with respect to the full cells of Example 5 and Comparative Examples 3 and 4. As air was supplied to the air electrode (cathode) and hydrogen gas was applied to the fuel electrode (anode), an open circuit voltage (OCV) of 1V or greater was obtained. To obtain I-V data, voltage drops were measured while increasing the current from 0 Ampere (A) to several Amperes until the voltage reached 0 V. I-P data were calculated from the I-V data. The resulting I-V and I-P results are shown in FIGS. 12 and 13. FIG. 12 is a graph comparing Example 5 and Comparative Example 3. FIG. 13 is a graph comparing Example 5 and Comparative Example 4.

Referring to FIGS. 12 and 13, the full cell (Comparative Example 3) using the LSCM anode had a maximum power density of about 0.07 W/cm², and the full cell (Comparative Example 4) using the Ni-LSCM anode had a maximum power density of about 0.063 W/cm². On the other hand, the full cell (Example 5) using the Ni_{0.7}Fe_{0.3}-LSCM composite anode material had a maximum power density of about 0.22 W/cm². Using the Ni_{0.7}Fe_{0.3}-LSCM composite anode material, cell performance increased by a factor of about three.

As described above, according to an embodiment, an anode material for a SOFC provides reduced anode polarization resistance, and thus low electrode resistance may be maintained even at a low temperature of 800° C. or less, and power of the SOFC may be increased.

It should be understood that the exemplary embodiments described herein should be considered in a descriptive sense only and not for purposes of limitation. Descriptions of features, advantages, or aspects within each embodiment should be considered as available for other similar features, advantages or aspects in other embodiments.

What is claimed is:

1. A composite anode material for a solid oxide fuel cell (SOFC), the composite anode material comprising:
a Ni-containing alloy comprising Ni and a transition metal other than Ni; and
a perovskite metal oxide having a perovskite structure.

2. The composite anode material of claim 1, wherein the Ni-containing alloy is represented by Formula 1:
Ni₁₋ₓM^{a}ₓ Formula 1
wherein M^{a} is at least one selected from iron (Fe), cobalt (Co), manganese (Mn), copper (Cu), and zinc (Zn), and 0<x≦0.4.

3. The composite anode material of claim 2, wherein M^{a} is Fe or Co.

4. The composite anode material of claim 2, wherein x satisfies 0<x≦0.3.

5. The composite anode material of claim 1, wherein the perovskite metal oxide is represented by Formula 2:
AM^{b}O_{3-δ} Formula 2
wherein A is at least one selected from a lanthanide, a rare earth element, and an alkaline-earth element,
M^{b} is at least one selected from a transition metal, and
δ is selected such that the perovskite metal oxide represented by Formula 2 is electrostatically neutral.

6. The composite anode material of claim 5, wherein the perovskite metal oxide is represented by Formula 3:
A′₁₋ₓA″ₓM^{b}′_{1-y}M^{b}″_{y}O_{3-δ} Formula 3
wherein A′ is at least one selected from lanthanum (La) and barium (Ba),
A″ is at least one selected from strontium (Sr), calcium (Ca), samarium (Sm), and gadolinium (Gd),
M^{b}′ and M^{b}″ are different and are each independently at least one selected from chromium (Cr), manganese (Mn), iron (Fe), cobalt (Co), nickel (Ni), copper (Cu), titanium (Ti), vanadium (V), niobium (Nb), ruthenium (Ru), and scandium (Sc),
0≦x<1, 0≦y<1, and
δ is selected such that the perovskite metal oxide represented by Formula 3 is electrostatically neutral.

7. The composite anode material of claim 1, wherein the perovskite metal oxide comprises at least one selected from lanthanum strontium chrome manganese oxide (LSCM), lanthanum strontium chrome vanadium oxide (LSCV), lanthanum strontium chrome ruthenium oxide, lanthanum strontium chrome nickel oxide, lanthanum strontium chrome titanium oxide, lanthanum strontium titanium cerium oxide, lanthanum strontium cobalt iron oxide (LSCF), lanthanum calcium chrome titanium oxide, lanthanum strontium gallium magnesium oxide, barium strontium cobalt iron oxide (BSCF), barium strontium cobalt titanium oxide (BSCT), and barium strontium zinc iron oxide (BSZF).

8. The composite anode material of claim 1, wherein the Ni-containing alloy and the perovskite metal oxide are a composite comprising a nano-sized particle.

9. The composite anode material of claim 1, wherein an amount of the Ni-containing alloy is about 1 weight percent to about 99 weight percent, and
wherein an amount of the perovskite metal oxide is about 1 weight percent to about 99 weight percent, each based on a total weight of the Ni-containing alloy and the perovskite metal oxide.

10. An anode for a solid oxide fuel cell (SOFC) comprising the composite anode material of claim 1.

11. A solid oxide fuel cell (SOFC) comprising:
an anode comprising the composite anode material of claim 1;
a cathode facing the anode; and
a solid oxide electrolyte disposed between the anode and the cathode.

12. The SOFC of claim 11, wherein the anode has a thickness of about 1 micrometer to about 1000 micrometers.

13. The SOFC of claim 11, wherein the solid oxide electrolyte comprises at least one selected from a zirconia which is undoped or comprises at least one selected from yttrium (Y), scandium (Sc), calcium (Ca), and magnesium (Mg); a ceria which is undoped or comprises at least one selected from gadolinium (Gd), samarium (Sm), lanthanum (La), ytterbium (Yb), and neodymium (Nd); a lanthanum gallate which is undoped or comprises at least one selected from strontium (Sr) and magnesium (Mg); and a bismuth compound which is undoped or comprises at least one selected from calcium (Ca), strontium (Sr), barium (Ba), gadolinium (Gd), and yttrium (Y).

14. The SOFC of claim 11, wherein the cathode comprises at least one selected from (La,Sr)MnO₃, (La,Ca)MnO₃, (Sm,Sr)CoO₃, (La,Sr)CoO₃, (La,Sr)(Fe, Co)O₃, (La,Sr)(Fe,Co,Ni)O₃, and (Ba,Sr)(Co,Fe)O₃.

15. The SOFC of claim 11, wherein the cathode comprises a compound represented by Formula 4:
Ba_{a′}Sr_{b′}Co_{x′}Fe_{y′}M′_{1-x′-y′}O_{3-η}
wherein M′ is at least one selected from a transition element and a lanthanide,
a′ and b′ satisfy 0.4≦a′≦0.6, and 0.4≦b′≦0.6, respectively,
x′ and y′ satisfy 0.6≦x′≦0.9, and 0.1≦y′≦0.4, respectively, and
η is selected such that the compound represented by Formula 4 is electrostatically neutral.

16. The SOFC of claim 15, wherein M′ is at least one selected from Mn, Zn, Ni, Ti, Nb, Cu, Ho, Yb, Er, and Tm.

17. The SOFC of claim 11, further comprising a functional layer disposed between the cathode and the solid oxide electrolyte which is effective to prevent a reaction between the cathode and the solid oxide electrolyte.

18. The SOFC of claim 17, wherein the functional layer comprises at least one selected from gadolinia-doped ceria (GDC), samaria-doped ceria (SDC), and yttria-doped ceria (YDC).
